(19) United States
(12) Patent Application Publication
(10) Pub. No.: US 2010/0040189 A1
(43) Pub. Date: Feb. 18, 2010

(54) ERBIUM-CONTAINING ZIRCONIUM ALLOY, METHODS FOR PREPARING AND SHAPING THE SAME, AND STRUCTURAL COMPONENT CONTAINING SAID ALLOY.

(75) Inventors: Jean-Christophe Brachet, Villebon-sur-Yvette (FR); Christine Chabert, Venelles (FR); Patrick Olier, Chatillon (FR); Stéphane Urvoy, Clamart (FR)

Correspondence Address: BROWDY AND NEIMARK, P.L.L.C.;624 NINTH STREET, NW, SUITE 300, WASHINGTON, DC, 20001-5303, US

(73) Assignee: Commissariat A L'Energie Atomique, Paris (FR)

(21) Appl. No.: 12/445,869

(22) PCT Filed: Oct. 16, 2007
(86) PCT No.: PCT/FR07/01698

§ 371 Date: Oct. 16, 2009

(30) Foreign Application Priority Data
Oct. 16, 2006 (FR) 0609047

(51) Int. Cl. G21C 3/20

(52) U.S. Cl. 376/419

(57) ABSTRACT

A zirconium alloy, comprising erbium as a burnable neutron poison, said alloy comprising, by weight:
from 3 to 12% erbium;
from 0.005 to 5% additional elements such as additives and/or manufacturing impurities;
the remainder zirconium.

A structural component comprising such a zirconium alloy.

Processes for manufacturing and shaping the zirconium alloy by a powder metallurgy or a melting process.

### FIELD OF THE INVENTION

This invention pertains generally to the nuclear field, in particular to nuclear fuel, and relates to an erbium-containing zirconium alloy, a structural component containing this alloy, and methods for manufacturing and shaping this alloy.

In particular, such an alloy is intended for the manufacture of a constituent element of a fuel assembly (such as a cladding) in a nuclear reactor which uses water as the coolant, notably in a Pressurized Water Reactor (PWR), a Boiling Water Reactor (BWR), or a nuclear propulsion reactor, and more generally for any reactor core or nuclear boiler, whether compact or not, which requires adjustable and/or time-varying neutron negative reactivity. This alloy may also be used in any type of reactor operating at high burnup rates.

### BACKGROUND OF THE INVENTION

Producers of nuclear-based power attempt to reach the permanent objective of increasing the availability of their power plant park and reducing the cost of the power produced. For example, in a PWR or BWR reactor, one of the means implemented to reach this objective consists in increasing the cycle length and correspondingly, the burnup rate. Thus, discharge burnups greater than 70 GWd/t (billion watt-days per ton) are targeted. This concept necessarily imposes an increase in the initial over-reactivity (²³⁵U enrichment) and reactivity (²³⁵U enrichment) and therefore improved means of control to compensate for this reactivity increase at the beginning of the burnup cycle.

Furthermore, the same increased need for negative reactivity is necessary if it is desired to obtain an increased consumption of plutonium-containing fuel (such as MOX (Mixed Oxide, a fuel based on mixed uranium and plutonium oxides)) in order to recycle and burn the plutonium stocks.

Finally, a similar need is found in the case of nuclear power applications which require a large power reserve (such as nuclear propulsion) and more generally, for compact nuclear boiler cores which in practice require accurate and adaptable neutron negative reactivity.

With this objective of compensating for the increase in fuel reactivity at the beginning of the burnup cycle of a nuclear reactor and as required during the course of fuel burnup, the designers of PWR reactors adopted, as a reference solution, to use boron in the form of boric acid H₃BO₃ dissolved at varying concentrations in the primary circuit's water. As a consequence of the uniform distribution of boric acid within the core, this neutron poison does not alter the radial power distribution. However, in view of, inter alia, problems of safety, degradation of the negative moderator temperature coefficient of the core and corrosion, as described in patent application FR 2789404 [1], it is desirable to restrict the initial concentration of soluble boron.

For that purpose, it is sometimes necessary to use another neutron poison in addition to boron. This is generally a solid neutron poison (which does not expand when the temperature increases). Because the over-reactivity to be compensated for diminishes and disappears along with fuel burnup, it is required that in parallel to this, the neutron this, the neutron poison disappears and that its residual penalty be as small as possible. Therefore, burnable neutron poisons are used, which disappear through neutron capture during the irradiation cycle(s).

So far, the reference burnable neutron poison for PWRs is gadolinium. It is used in the form of an oxide mixed in an appropriate proportion with uranium oxide in a number of rods of the fuel assembly (so-called “heterogeneous” poisoning).

However, this mode of use also has its shortcomings. For instance, introducing gadolinium directly into the fuel, in addition to contaminating the fuel production lines, contributes to a deterioration of its thermal conductivity with a resulting growth of hot spots. Furthermore, the compatibility of gadolinium with other fuels such as MOX is uncertain and complex to implement. Finally, the poisoning is achieved by introducing gadolinium into some rods of the assembly: consequently, it is heterogeneous and also affects the assembly's radial power distribution.

Even though this poisoning mode offers some advantages in achieving a burnup rate of approximately 60 to 70 GWd/t in current PWR managements and the future reference management of reactors of the European Pressurized Reactor (EPR) type, it still appears that, as regards the objective of remedying the above-mentioned issues and further extending cycle lengths and therefore discharge burnup rates to as much as 100-120 GWd/t, for example, the use of another burnable neutron poison, namely erbium, is more appropriate.

Of the six stable isotopes present in natural erbium, the three isotopes ¹⁶⁶Er, ¹⁶⁷Er and ¹⁶⁸Er are predominant. ¹⁶⁷Er is the absorbing isotope in the chain, with ¹⁶⁶Er being its precursor and ¹⁶⁸Er being considered as the final nucleus. the final nucleus. This erbium isotope is not radioactive and therefore has the advantage of not generating any additional amount of radioactive waste.

Because of its smaller absorption cross-section than that of gadolinium, the wear kinetics of erbium are slower: this burnable neutron poison is therefore better suited to longer cycles. Its larger resonance integral reflects much steadier absorption during the cycle because it is less dependant on a large thermal cross-section such as that of ¹⁵⁷Gd. The neutronically predominant isotope ¹⁶⁷Er has two thermal resonances at E₀=0.46 eV and E₀=0.58 eV. These resonances extend over the side-lobe of the large resonance peak of ²³⁹Pu at 0.3 eV. Because of this mutual protection effect, erbium is also an excellent burnable neutron poison for Light Water Reactors of the LWR MOX type.

Due to the neutronic characteristics of erbium, the poisoning mode with the highest performance is the homogeneous mode, namely a distribution of burnable neutron poison throughout the fuel rods grouped into the assembly. The radial power distribution of the assembly thus remains unaffected.

Based on this observation and on the disadvantages of directly introducing the burnable neutron poison into the fuel pellet, the most appropriate concept consists in combining erbium with the rod cladding which encloses the fuel pellets (thereafter referred to as the “nuclear fuel cladding”). This cladding, which typically consists of a zirconium alloy, may be in the form of a tube or plate according to the foreseen applications.

By combining erbium with this cladding rather than the fuel, a volume is freed wherein a larger amount of fuel pellets may be placed, thus helping to improve the energy efficiency of the rod assembly.

Erbium may be used in its naturally occurring proportions, but provision may also be made for the introduction of erbium enriched with an absorbing isotope, namely ¹⁶⁷Er, or a combination of isotopically enriched erbium and natural erbium. It may also be envisioned to associate it with another neutron poison.

Several solutions allowing erbium to be combined with a nuclear fuel cladding have been proposed so far. They may be classified according to the number of layers composing this cladding, at least one of these layers incorporating erbium.

The first family of solutions, which is a priori the most straightforward to implement, consists in incorporating an appropriate content of erbium into a nuclear fuel cladding consisting of a single layer of zirconium alloy.

This family of solutions is disclosed in U.S. Pat. No. 5,267,284 [2] which proposes to incorporate into a zirconium alloy (such as Zircaloy®-2 or Zircaloy®-4) between 0.1% and 0.4% by weight of the isotope ¹⁶⁷Er, which is the most efficient isotopic form of erbium with respect to the desired neutron negative reactivity. The solution proposed therein has the disadvantage that incorporating erbium exclusively in the form of the ¹⁶⁷Er isotope, although promoting the use of a lesser quantity of erbium for the same neutron efficiency, leads to increased production costs, which may prove to be prohibitive, because of the isotopic separation technologies needed to extract the ¹⁶⁷Er isotope from natural erbium.

patent application FR 2789404 [1], for its part, suggests incorporating natural erbium as a burnable neutron poison into a nuclear fuel cladding in the range between 0.1% and 3.0% by weight in a zirconium alloy containing more than 0.6% by weight of niobium. The only embodiment example embodiment example described in this application relates to the manufacture through arc melting of a rolled sheet composed of a zirconium alloy incorporating, by weight, 1% niobium and 1.6% erbium.

However, this technology has some drawbacks and limitations, some of which will be described below. Specifically, a microstructural analysis of the erbium-containing zirconium alloy of the rolled sheet reveals the presence of coarse precipitated erbium oxides (having an average size of the order of 1 micrometer or even more), which are detrimental to the mechanical properties, as illustrated in the examples below. Generally speaking, there is no example demonstrating that not only the mechanical but also the neutronic properties, as imposed by the specifications of a nuclear fuel cladding, in particular for applications requiring very high burnup rates (greater than 70 GWd/tU), can be achieved.

A second family of solutions relates to a two-layer nuclear fuel cladding, wherein one internal layer of erbium-containing zirconium alloy is interposed between the fuel and the external layer of this cladding consisting of an already qualified industrial-grade alloy, which, in particular, is able to resist to corrosion.

This two-layer nuclear fuel cladding concept is illustrated by U.S. Pat. No. 5,241,571 [4] which proposes to incorporate different chemical elements and erbium in the range between 0.05% and 2% by weight into a zirconium alloy derived from Zircaloy®-4.

This is also illustrated in U.S. Pat. No. 5,267,290 [5] wherein the external layer consists of a zirconium alloy of the Zircaloy®-2 or Zircaloy®-4 type and the internal layer consists of a low-alloyed zirconium alloy incorporating various chemical elements (among which silicon) and either natural erbium in the range of up to about 20% by weight or about 20% by weight or the ¹⁶⁷Er isotope in the range of up to about 5% by weight.

When the patents relating to the above-mentioned two families of solutions are globally reviewed, the following limitations are revealed:

i) there is an objectionable problem of corrosion resistance of the erbium-containing zirconium alloy layer when the nuclear fuel cladding which contains it is put to use in an oxidizing medium, such as pressurized water (PWR) or water vapor (BWR). Indeed, the ability of erbium to induce corrosion of zirconium alloys at the operating temperature of a nuclear reactor was revealed in H. H. Klepfer, D. L. Douglass, J. S. Armijo, “Specific zirconium alloy design program”, First Quaterly Progress Report, (February-June 1962), GEAP-3979, US Atomic Energy Commission [3].

On the other hand, the formation of coarse erbium oxide precipitates (with an average size of the order of 1 micrometer or even more) generated by the heat processes involved in the manufacturing and/or shaping treatments (such as the so-called beta-phase zirconium “homogenization” processes at high temperature (≧1000° C.) commonly used in the upstream stage of the manufacturing sequence) may prove particularly detrimental to mechanical properties such as, for example, ductility (the ability of a material to deform plastically without breaking) and toughness (the property of a material having both a maximum tensile strength (the so-called mechanical strength) and a low tendency to propagate cracks) which could already be expected to deteriorate due to erbium's poor solubility at low temperature (namely 600° C. or less) in the zirconium-alpha.

Also, oxidation tests performed in an autoclave at 350° C. in pure pressurized water on zirconium alloys comprising 1.5% to 10% by weight of erbium have confirmed that erbium greatly or even prohibitively accelerated corrosion under such conditions.

Thus, in practice, when either the external face of the nuclear fuel cladding, for the first family of solutions, or the internal layer of a two-layer nuclear fuel cladding, in case of accidental piercing or cracking of such cladding, for the second family of solutions, is brought in contact with the oxidizing medium, the rate of oxidation of the zirconium alloy is then strongly increased because of the erbium it contains. This oxidation may lead to embrittlement of the cladding, possibly followed by its deterioration or even destruction. This renders the concepts of these first two families of solutions dangerous and hardly acceptable with regard to safety, since the nuclear fuel could spill outside its cladding.

ii) during shaping steps such as extrusion or rolling, the layer of the erbium-containing nuclear fuel cladding remains in prolonged contact (strong friction) with the tooling. This will necessarily lead to more or less fast contamination of the tooling and to the possible production of debris and chippings containing a significant quantity of erbium. As a result, when the production lines are used to shape other products made of a “more standard” zirconium alloy (for example industrial-grade cladding alloys of the Zircaloy®-2 and Zircaloy®-4, M5® type, or the like) for which the specifications impose particularly small impurity levels of neutrophage elements such as erbium, these products run the risk of being exposed to uncontrolled surface contamination. This requires a surface finish and additional complex inspection steps, or even dedicating an entire production line to the manufacture of the internal layer of erbium-containing zirconium alloy and/or of the whole nuclear containing zirconium alloy and/or of the whole nuclear fuel cladding comprising this internal layer. The above would thus lead to prohibitive “additional manufacturing costs”;

iii) whatever document is considered, the desired properties for a nuclear fuel cladding have neither been characterized nor, therefore, validated, in particular with regard to the mechanical and/or neutronic properties.

Finally, a third family of solutions pertains to a three-layer nuclear fuel cladding in which an intermediate layer containing erbium as the burnable neutron poison is interposed between an external layer and an internal layer consisting of a zirconium alloy.

U.S. Pat. No. 6,426,476[6] proposes solutions for the manufacture of multilayer plates, one of the layers at least consisting of a rare earth element. In particular, this patent describes the feasibility of a three-layer plate: the external and internal layers consist of Zircaloy®-4 and the intermediate layer consists of pure erbium (the layer therefore does not contain any zirconium) in the form of a thin sheet of metal (100 to 200 μm). The disclosed embodiment examples show the following:
the impossibility of making a three-layer structure that can be co-laminated in a cold and even a hot state (800° C.) through conventional processes;
the possibility to obtain a three-layer plate of Zircaloy®-4/erbium/Zircaloy®-4 which could be successfully co-laminated using a prior deposition process according to the so-called “electrospark-deposition” (ESD) technique under a controlled atmosphere.

In fact, the technology described therein suffers from limitations and shortcomings which are sometimes unacceptable for a nuclear fuel cladding:
the above-described manufacturing processes appear to be complex, lengthy, costly and not straightforwardly transposable to industrial-scale production;
only claddings in the form of thin platelets could be made. However, in view of the foregoing limitations of the manufacturing processes, the manufacture of fuel cladding tubes with more complex geometries seems to be extremely difficult or even impossible to carry out;
the choice of using pure erbium in the form of a metal sheet is costly and complex because it is necessary, at each manufacturing step, to prevent erbium oxidation, since this material has a particularly strong affinity with oxygen. Furthermore, its use in a three-layer nuclear fuel cladding leads to a structure having abrupt metallurgical discontinuities between the various layers. From a mechanical point of view, such a structure is not adapted to in-service and/or accidental temperature cycling (for example, differential expansion phenomena resulting in exfoliation may be feared). From the point of view of the neutron irradiation effect (which damages the metal matrix through “ballistic” shocks caused by neutrons on the crystal lattice), under irradiation a different and penalizing behavior of pure erbium may be expected with respect to zirconium alloys, once again leading to differential swelling, embrittlement phenomena, and the like.

Finally, among the third family of solutions, it should be noted that although the above-mentioned patent application FR 2789404 [1] discusses the possibility of making a two- or three-layer nuclear fuel cladding, there is no embodiment example to support this possibility, in particular as regards particular as regards the manufacture of a nuclear fuel cladding shaped as a tube. The adequacy of the properties of such a cladding with regard to the expected specifications is a fortiori not described, in particular with respect to its mechanical, neutronic or microstructural properties (such as the metallurgical and mechanical continuity between the three layers). Neutron calculations have shown that an intermediate layer having a significantly smaller thickness than the total thickness of the cladding (that is, an intermediate layer having a thickness which is typically ⅙ and at most ⅔ of the total thickness) and consisting of a zirconium alloy containing natural erbium in the range between 0.1% and 3.0% by weight, does not allow the targeted poisoning to be met throughout the volume of the nuclear fuel cladding, within the scope of use of such a cladding at high burnup rates of up to 120 GWd/t.

The above-mentioned shortcomings and limitations of the single-layer cladding also disclosed in patent application FR 2789404 [1] are of course still applicable when a three-layer cladding is envisioned.

### SUMMARY OF THE INVENTION

It is accordingly an object of this invention to remedy the problems and shortcomings of existing techniques by providing an erbium-containing zirconium alloy whose ductility allows the manufacture and shaping of a structural component comprising this alloy (which component, for example a nuclear fuel cladding, may take various shapes, for example the shape of a plate or a tube), but also whose mechanical strength and toughness ensure good mechanical performance of this component, in particular at the operating temperatures of a nuclear reactor and/or under neutron irradiation.

A further object of this invention is to provide a zirconium alloy containing a sufficient quantity of erbium as a burnable neutron poison so that this alloy may be incorporated into a component such as a nuclear fuel cladding, so as to permit an increase in the burnup cycle length and correspondingly in the burnup rate of a nuclear reactor, this being achieved in particular without incorporating erbium (or its ¹⁶⁷Er isotope) in its pure state or as a major constituent of a zirconium alloy within the cladding.

To achieve these and other objects, the present invention provides a zirconium alloy which contains erbium as the burnable neutron poison, the alloy comprising, by weight:
from 3 to 12% erbium, preferably from 4 to 10% erbium;
from 0.005 to 5% additional elements such as additives and/or manufacturing impurities;
and the remainder of zirconium.

According to the present invention, by “remainder zirconium” is meant the weight percentage of zirconium to be added to the erbium and to the additional elements in order to reach 100% by weight.

The additives incorporated into the zirconium alloy of the present invention are intended to enhance the properties of the alloy, in particular its mechanical properties.

This invention also relates to a structural component comprising a zirconium alloy.

Preferably, a component according to the present invention may consist of an internal structural element in a nuclear reactor core. For example, this may be a nearby element within the nuclear fuel space, such as a constituent constituent element of an absorber rod, guide tube or spacer grid. In particular, it may be a nuclear fuel cladding.

Still preferably, the component of the present invention is in the form of a plate, which, for example is a constituent of the structures of a plate fuel, or in the form of a tube.

This invention further relates to a powder metallurgy process for the manufacture and, if required, shaping of the zirconium alloy of the present invention, which process comprises sintering in an inert atmosphere or vacuum of the alloy in the form of a homogeneous powder, followed, if required, by at least one machining step.

Finally, this invention relates to a melting process for the manufacture and, if required, shaping of the zirconium alloy of the present invention, including the following steps, which are preferably performed in an inert atmosphere or vacuum, of:
melting and then solidifying a mixture of the zirconium, the erbium and the additional elements in a mold; and
if required, machining, such as milling and/or sandblasting.

As shown in the following embodiment examples, the fact that the zirconium alloy according to the present invention comprises 3 to 12% by weight of erbium (preferably 4 to 10%) has the advantageous effects i) that the laminability of such an alloy is sufficient to enable parts to be made, by means of the melting process of the present invention, whose final geometry is well-defined and ii) this content of erbium used as the burnable neutron poison makes it possible to produce a nuclear fuel cladding such that the length of the burnup cycles and, correspondingly, the burnup rate of a nuclear correspondingly, the burnup rate of a nuclear reactor, may be increased.

Other objects, features and advantages of the present invention will become more apparent from the following description, which is non-limitative and given for the purposes of illustration in conjunction with the accompanying drawings.

### BRIEF DESCRIPTION OF THE DRAWINGS

FIG. 1 illustrates the zirconium-erbium binary phase diagram taken from reference [7].

FIG. 2 illustrates micrographs obtained by thin-section transmission electron microscopy showing the state of precipitation of erbium oxides before (upper picture) and after the heat treatments have been optimized during the manufacturing sequence (lower picture) of an M5® alloy with about 1.6% by weight of erbium.

FIG. 3 shows the erbium distribution profile obtained by means of an electron microprobe within a plate of zirconium alloy comprising 17% by weight of erbium.

FIG. 4 illustrates an optical micrograph under polarized light obtained through the thickness of a three-layer nuclear fuel cladding.

FIGS. 5A and 5B illustrate the appearance of the internal surface of a nuclear fuel cladding comprising a single layer of erbium-free M5® zirconium alloy (5A), and two layers, namely an external layer of erbium-free M5® zirconium alloy and an internal layer of an erbium-containing “Zr-D” zirconium alloy (5B).

FIGS. 6A and 6B illustrate the macroscopic aspects of the internal pressure burst failure of the cladding sections shown in FIGS. 5A and 5B, respectively.

FIG. 7 illustrates the change in negative reactivity as a function of the burnup rate achieved by different neutron poisons.

FIG. 8 illustrates the weight composition of a low-alloyed zirconium alloy used for manufacturing an erbium-containing zirconium alloy according to the present invention.

FIGS. 9A and 9B illustrate an optical micrograph through the thickness of a single-layer and a three-layer nuclear fuel cladding respectively, both hydridized up to an overall content of 400 to 450 ppm by weight.

FIGS. 10A and 10B illustrate an enlarged view of a specific area of micrographs 9A (a randomly chosen area) and 9B (an area located just below the cladding's external surface), respectively.

### DETAILED DESCRIPTION OF THE INVENTION

### 1—Manufacture, by a Process of Melting, of the Alloy of the Present Invention and Mechanical Properties of the Obtained Alloy

Plates made of the erbium-containing zirconium alloy were manufactured and shaped using the melting process of the present invention.

Preferably, this melting process may further comprise one or more of the following steps, preferably performed in an inert atmosphere or vacuum:
remelting, followed by solidifying, in a mold;
a heat treatment;
a hot and/or cold shaping step, for instance rolling;
machining, such as milling and/or sandblasting.

Specifically, the melting process comprises the following sequence of steps performed, if required, in an inert atmosphere or vacuum:
remelting, followed by solidification;
a first heat treatment;
machining, preferably milling;
hot and/or cold shaping, preferably, rolling;
machining, preferably sandblasting;
a second heat treatment;
a final cold rolling;
a final heat treatment.

All chemical element contents indicated in the present description are given in parts-per-million (ppm) by weight or in percentages (%) by weight except when otherwise indicated.

1.1—Manufacture, by a Process of Melting, of Plates Consisting of the Zirconium Alloy According to the Present Invention.

Ingots of zirconium alloy with 6%, 10% and 17% by weight of erbium were made by arc-melting followed by shaping, to obtain plates approximately 1 mm in thickness, a few tens of cm in length and a few cm to 20 cm in width. Such plates may constitute the intermediate layer of a cladding having the composite structure according to the present invention.

To manufacture such alloys, a low-alloyed zirconium alloy with a purity of more than 99.5% (a so-called “grade D” alloy referred to as “Zr-D” with the weight composition shown in FIG. 8, wherein the contents of the various elements are in ppm by weight, except when otherwise indicated) was introduced together with metal erbium (having a purity of the order of 99.0%) in the form of nuggets of 10 to 50 grams in weight, into a copper crucible cooled by circulating water, and these were then melted under argon in an electric melting arc oven equipped with a non-consumable electrode so as to obtain three zirconium alloys with 6%, 10% and 17% by weight of erbium.

The rolling steps which then followed were performed on the “Zr-D” zirconium alloys comprising 0%, 6% and 10% by weight of erbium (the alloy with 17% by weight of erbium showing early crack formation during the initial hot rolling step) on a 73 kW reversing mill equipped with a double two-high mill for hot and cold rolling.

Optionally, according to the original composition of the zirconium alloy, which is melted together with erbium, the alloy according to the present invention may be a zirconium alloy wherein the additives comprise, by weight:
less than 3% niobium, preferably less than 0.1%;
less than 2% tin, preferably less than 0.1%;
less than 0.6% nickel, preferably less than 0.01%;
less than 0.6% molybdenum, preferably less than 0.01%;
less than 0.6% copper, preferably less than 0.01%;
less than 0.6% iron, preferably less than 0.1%;
less than 0.2% chromium, preferably less than 0.01%;
less than 0.16% oxygen in a solid solution, preferably less than 0.08%.

By “oxygen in a solid solution”, is meant oxygen in a solid solution within the zirconium-alpha matrix, namely that residual fraction of oxygen which has not precipitated in the form of erbium oxides and which is therefore present in the form of interstitial compound within the zirconium-alpha crystal structure of the matrix.

In particular, these additives may help impart or enhance various properties of the alloy according to the present invention. They may be added during the manufacturing process of the zirconium alloy according to the present invention and/or included in the original composition of the zirconium and/or erbium used for manufacturing the alloy manufacturing the alloy according to the present invention.

The oxygen content of the zirconium alloy according to the present invention may be adjusted as a function of the erbium previously added, taking into account the fact that all or part of this oxygen (to which the amount of oxygen incorporated into the alloy as a result of the manufacturing and/or shaping heat treatments should be added) will precipitate essentially in the form of erbium oxides, Er₂O₃, such that it is possible to target a residual solid solution oxygen content of less than 0.16% by weight (preferably, less than 0.08% by weight) within the structure of the zirconium alloy in order to compensate for the possible hardening and/or embrittlement effects of erbium.

Also, the zirconium alloy according to the present invention may comprise, by weight, the following manufacturing impurities:
less than 120 ppm silicon, preferably less than 40 ppm, and still more preferably less than 30 ppm;
less than 100 ppm sulfur, preferably between 10 and 100 ppm;
less than 20 ppm chlorine;
less than 10 ppm phosphorus, preferably between 2 and 10 ppm;
less than 10 ppm boron, preferably between 0.1 and 10 ppm;
less than 10 ppm calcium, preferably between 0.1 and 10 ppm;
less than 50 ppm, preferably less than 5 ppm, and still more preferably less than 0.1 ppm, of each of the following elements: lithium, fluorine, heavy metals.

The manufacturing impurities and their contents in the alloy according to the present invention are those typically found in industrial-grade zirconium alloys, and in any case, are such that the neutron efficiency and usual mechanical properties of the alloy of the present invention are not affected.

The procedures for manufacturing modes of these alloys will now be described in greater detail.

1.1.1—Manufacture, by a Process of Melting, of a Plate of Zirconium Alloy Comprising 6% by Weight of Erbium.

For the alloy with 6% by weight of erbium, a mold, such as a crucible, was used to melt a volume of about 45 cm³ of alloy, corresponding to a weight of the order of 300 grams.

Four remelting operations under argon, each followed by solidification, were then performed in order to promote proper chemical homogeneity, in particular a uniform distribution of erbium within the zirconium matrix.

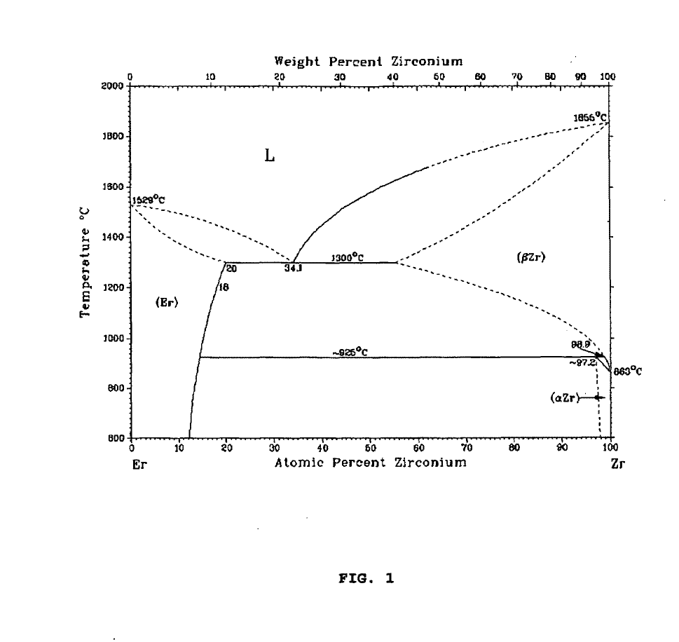

The ingots thus obtained, typically from 8 to 12 mm in thickness, about 10 to about 20 cm in length, and from 5 to 10 cm in width, were then removed from the crucible for heat treatment, namely homogenization annealing under vacuum for 1 hour at a temperature of 800° C., a temperature at which the zirconium has a predominantly zirconium-alpha microstructure (typically, more than 50% by volume), as illustrated for example in the phase diagram shown in FIG. 1. Thereafter, in preparation for rolling, the two faces of the ingots were milled in order to reduce the thickness of each face by approximately 1 mm so as to obtain ingots with a thickness between 8 and 10 mm.

These were hot rolled (at a maximum deformation ratio=50%) at a temperature of 700° C., down to a thickness of 5 mm, in three passes. They were then sandblasted to remove sandblasted to remove surface oxidation and were heat treated at 580° C. under vacuum for 5 hours.

A first cold rolling operation (at a maximum deformation ratio of ε=60%) to reduce the ingot's thickness to 2 mm, was followed by a second cold rolling operation (at a deformation ratio of ε=40%) to obtain a plate with a thickness of 1.2 mm, each rolling operation being followed by annealing under vacuum at 580° C. for 5 hours.

1.1.2—Manufacture, by a Process of Melting, of a Plate of Zirconium Alloy Comprising 10% by Weight of Erbium.

For the alloy with 10% by weight of erbium, a smaller mold was used, such as a crucible, which allowed a volume of about 10 cm³ of alloy, or a weight of the order of 65 grams, to be melted.

With the same objective as above, five remelting operations under argon, each followed by solidification, were then performed.

The ingots thus obtained, of 8 mm in thickness, about 10 cm in length, and a few centimeters in width, were then removed from the crucible for heat treatment, namely homogenization annealing under vacuum for 1 hour at a temperature of 800° C. Thereafter, in preparation for rolling, the two faces of the ingots were milled to obtain ingots of 6 mm in thickness.

The rolling steps that followed were somewhat different from those previously applied to the ingots consisting of the zirconium alloy with 6% by weight of erbium, so as to take into account the higher content of erbium and the pyrophoric nature of this element.

Thus, the ingot consisting of the zirconium alloy with 10% by weight of erbium was placed in a strickle made of a zirconium alloy of the Zircaloy®-4 type, which alloy is well is well known to those skilled in the art. This strickle was sealed by edge welding in order to protect the ingots from possible oxidation and restrict thermal gradients during rolling.

These ingots were hot co-laminated (at a maximum deformation ratio of ε=76%) at a temperature of 700° C. down to a thickness of 1.4 mm. They were then sandblasted to remove any surface oxidation, and heat treated at 700° C. under vacuum for 1 hour.

Thereafter, through cold rolling (at a maximum deformation ratio of ε=21%), a plate of 1.1 mm in thickness was obtained, corresponding to the minimum thickness required for the collection of tensile test specimens to be used in the mechanical tests described below. Finally, a last annealing step was performed at 700° C. under vacuum for 1 hour.

1.1.3—Manufacture, by a Process of Melting, of a Zirconium Alloy Comprising 17% by Weight of Erbium.

A zirconium alloy comprising 17% by weight of erbium was prepared according to the same procedure as in the previous example (zirconium alloy plate with 10% by weight of erbium), except for the rolling steps required to obtain the desired final geometries, since it was found that an alloy with such an erbium content has little ability to be rolled even in the hot state.

Thus, it was possible to determine by means of a variety of tests that a sufficiently adequate laminability (and therefore, ductility) could be obtained only for zirconium alloys comprising, by weight, from 3 to 12% erbium (preferably, 4 to 10%).

1.2—Microstructure of a Zirconium Alloy According to the Present Invention Manufactured by a Melting Process

As discussed above, patent FR 2789404 [1] discloses the precipitation of coarse erbium oxides into an alloy comprising approximately 1.6% by weight of erbium, due to the “conventional” manufacturing and/or shaping heat-treatment(s) which has (have) been applied.

Such oxide inclusions are a priori detrimental to ductility and there was nothing to suggest that satisfactory mechanical properties of the zirconium alloy according to the present invention could be obtained.

Indeed, such a microstructure appears to be too coarse to lead to acceptable mechanical properties, in particular when employed in a nuclear environment.

In this respect, an advantageous feature of the melting process according to the present invention is that at least one of the heat treatments, preferably the first post-solidification homogenizing heat treatment, consists in a heating (preferably under vacuum or in an inert atmosphere) to a temperature such that the zirconium alloy has a microstructure which comprises—at the heat treatment temperature—more than 50% of zirconium-alpha, preferably more than 70%, and still more preferably more than 90%.

Such a heat treatment will restrict or even suppress the growth/coalescence of erbium oxides while at the same time allowing a uniform distribution of erbium to be preserved in the zirconium alloy of the present invention and/or prevent the segregation of erbium in the form of erbium precipitates which in particular may be too coarse, that is to say, having an average size of 1 micrometer or more.

Thus, in such an embodiment, the melting process of the present invention is such that, for example, at least one of the heat treatments, preferably the first heat treatment, consists in a heating step (preferably under vacuum or an inert atmosphere) to a temperature in the range between 600° C. and 1000° C., preferably 800° C. (for example for 1 hour), the example for 1 hour), the latter temperature corresponding to a microstructure comprising more than 90% zirconium-alpha for the zirconium alloy according to the present invention, as manufactured according to Example 1.

FIG. 2 illustrates an exemplary microstructure optimized in this manner (lower picture) and as seen by thin-section transmission electron microscopy, which is to be compared to the original microstructure which was not optimized by the melting process according to the present invention as described in patent FR 2789404 [1] (upper picture). It may be observed that the erbium oxides become highly refined with a size of the order of a few tens to a few hundreds of nanometers, which refinement is essential to obtain sufficient improvement of the ductility and/or toughness of such an alloy.

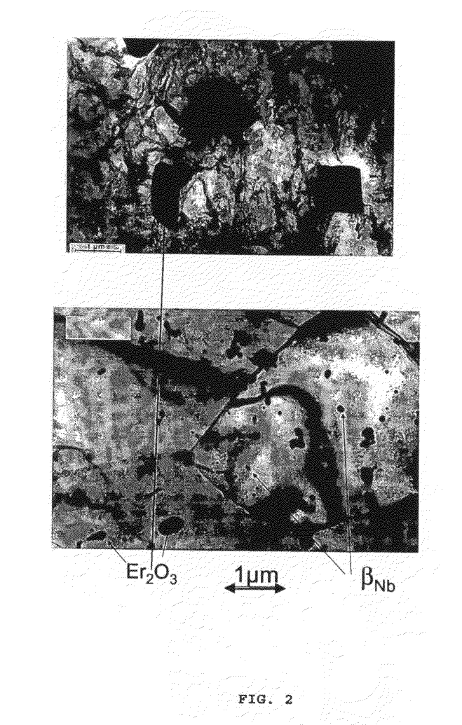

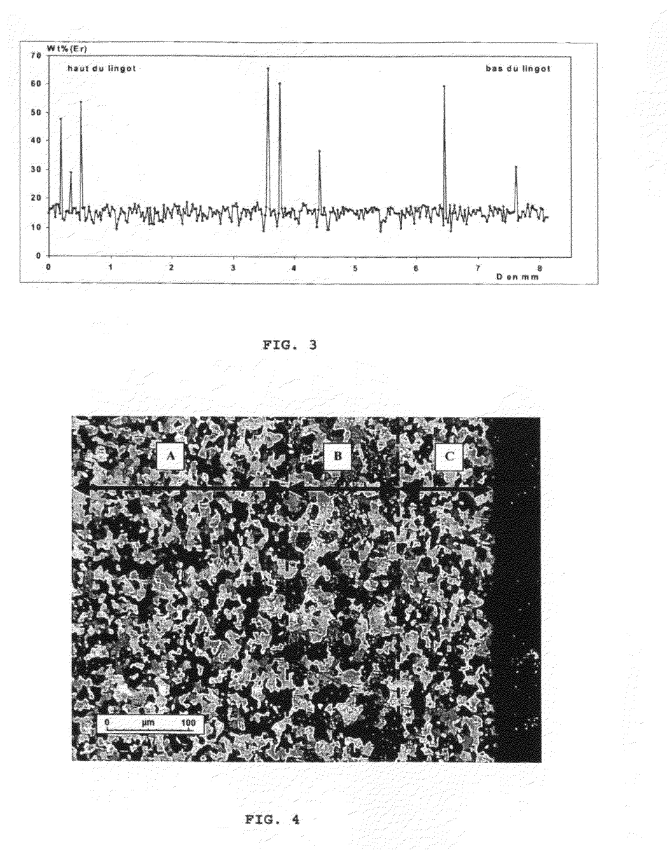

Using an electron microprobe, a distribution profile of erbium in a zirconium alloy comprising 17% by weight of erbium was derived in a post-solidification raw ingot, that is, an ingot obtained directly after the above-mentioned remelting operations. This profile is shown in FIG. 3, which illustrates a macroscopically uniform distribution of erbium even though, locally, enrichments caused by a few erbium oxide precipitates were observed. An even more homogeneous distribution is obtained for zirconium alloys containing 6% and 10% by weight of erbium.

Thus, according to one preferred aspect of the present invention, erbium is distributed uniformly within the zirconium alloy of the present invention and/or there is no detectable or significant segregation/fluctuation of erbium in the form of erbium precipitates, in particular coarse precipitates (that is to say, having an average size of more than 1 micrometer).

According to another preferred aspect of the present invention, all or part of the erbium is present in the zirconium alloy in the form of complex oxide precipitates, which, by weight, contain mainly erbium. Preferably, the oxide precipitates are distributed uniformly within the zirconium alloy and/or have an average size of one micrometer or less, and more preferably, of 500 nanometers or less, and still more preferably, lie in the range between 5 nanometers and 200 nanometers, given that a reduction of this size within the zirconium alloy of the present invention is associated with better metallurgical continuity, better mechanical properties (in particular ductility and/or toughness) as well as a more uniform distribution of hydrogen, for example in the case where a nuclear fuel cladding comprising such an alloy is hydridized.

The term “complex oxides” as used herein means oxides comprising erbium and possibly zirconium and/or certain additives and/or manufacturing impurities. In particular, these may be the “pure” form of Er₂O₃ oxide. Also, the term “average size” means the average value of the diameter of precipitated oxides when they are substantially spherical, or the average value of the main dimensions of such objects when they are not substantially spherical.

1.3—Usual Tensile Mechanical Characteristics.

The usual tensile mechanical characteristics obtained at 20° C. and 325° C. (the latter temperature being close to the temperatures of a nuclear fuel cladding in an operational PWR reactor) were measured twice on different tensile test specimens taken from alloy plates manufactured in the above examples according to the melting process of the present invention. The plates were made by melting erbium together with the so-called “Zr-D” low-alloyed zirconium alloy. All of low-alloyed zirconium alloy. All of these materials are in the recrystallized state.

So that the properties of the erbium-containing zirconium alloys of the present invention may be compared reliably with those of the same reference alloys (without erbium), these alloys must all be prepared according to the same sequence, that is, they must have gone through the same manufacturing and shaping steps. Due to the manufacturing means involved, the structures, crystallographic textures and properties of the zirconium alloys of the present invention may be further optimized as a function of the desired final geometry (such as a plate or a tube) and as a function of the usual mechanical stress to be taken into account.

Table 1 below shows the results of the mechanical tests performed.

The abbreviations used in Table 1 correspond to the usual quantities derived from a mechanical tensile test, namely:
Rp 0%=conventional limit of elasticity at 0% plastic deformation;
Rp 0.2%=conventional limit of elasticity at 0.2% plastic deformation;
Rm=ultimate tensile strength (also referred to as the mechanical strength);
Ar=uniform elongation (uniform plastic elongation up to Rm);
At=total elongation at break, which allows ductility to be accounted for.

TABLE 1

| Kind of | Temper- | | | | | |
|---|---|---|---|---|---|---|
| alloy (plate | ature | Rp 0% | Rp 0.2% | Rm | Ar | At |
| geometry) | (° C.) | (Mpa) | (Mpa) | (Mpa) | (%) | (%) |
| “Zr-D” | 20 | 145 | 192 | 321 | 16.3 | 38 |
| reference | | 146 | 191 | 307 | 16.6 | 38.3 |
| without | 325 | 48 | 63 | 123 | 36.0 | 65.7 |
| erbium | | 38 | 55 | 114 | 36.0 | 78.0 |
| “Zr-D” + | 20 | 207 | 245 | 401 | 16.7 | 35.2 |
| 6% erbium | | 203 | 241 | 395 | 17.8 | 35.4 |
| | 325 | 92 | 129 | 231 | 17.7 | 31.0 |
| | | 97 | 132 | 235 | 18.1 | 32.2 |
| “Zr-D” + | 20 | 107 | 209 | 374 | 12.7 | 21.7 |
| 10% erbium | | 102 | 221 | 373 | 11.1 | 21.3 |
| | 325 | 70 | 109 | 187 | 10.5 | 21.9 |
| | | 62 | 112 | 212 | 7.0 | 17.2 |

It may be noted that, although they are low-alloyed, the two erbium-containing alloys have mechanical characteristics which remain satisfactory when compared to the same reference alloy without erbium, since the incorporation of erbium is generally associated with an increase in the mechanical strength and a corresponding decrease in ductility.

Specifically, Table 1 shows that the zirconium alloy comprising 6% erbium has optimum values of the parameters Rp 0%, Rp 0.2% and Rm which account for the alloy's mechanical strength, while preserving satisfactory ductility values (the parameters At and Ar). By means of complementary measurements it was possible to confirm a similar mechanical behavior with an erbium content of 4 to 8% by weight.

Thus, preferably, the zirconium alloy of the present invention comprises 4 to 8% by weight of erbium.

Still more preferably, the zirconium alloy of the invention comprises 5 to 7% by weight of erbium, preferably about 6%.

The above-mentioned mechanical behavior, which is specific to a range of erbium contents lying between 4 and 8% by weight was quite unexpected, since one skilled in the art could not anticipate the influence of the addition of erbium on the mechanical properties of such a zirconium alloy.

Indeed, for the specific content range of 4 to 8% by weight of erbium, the zirconium alloy of the present invention has a two-phase microstructure (an erbium-containing zirconium-alpha matrix), or even a three-phase microstructure if the potential additional precipitation of erbium oxides is taken into account; which unexpectedly shows i) a non-significantly reduced ductility, ii) an optimum value of the mechanical strength (whereas a steady increase or decrease should be expected), iii) this optimum having a value, both at 20° C. and 325° C. (average operating temperature of a PWR nuclear fuel cladding), which is very close to the limit of elasticity and mechanical strength of an industrial-grade zirconium alloy such as the M5® zirconium alloy which is a constituent of the internal and external layers of a three-layer nuclear fuel cladding according to the present invention.

Therefore, quite unexpectedly, the zirconium alloy of the present invention which comprises 4 to 8% by weight of erbium has an optimal mechanical strength while at the same time preserving a non-significantly reduced ductility (in particular at 20° C.), which in any event, is sufficient to allow this alloy to be shaped, for example according to the melting process of the present invention.

In practice, this is a fundamental advantage when such a zirconium alloy is introduced into the composition of a nuclear fuel cladding, in particular into the intermediate layer of a three-layer nuclear fuel cladding such as the one described below.

Indeed, in such a cladding, each layer possesses its own mechanical characteristics. However, within a nuclear reactor under its operating conditions (comprising irradiation and numerous temperature cycles, . . . ) or even under accidental conditions, each layer of such a cladding exhibits a specific mechanical behavior which may be incompatible with that of the other layers.

The fact that there is a remarkable and unexpected mechanical strength continuity between the different layers minimizes risks such as those of “exfoliation” and/or localized damage at the interface between layers, which may lead to cracking and possibly result in the destruction of the nuclear fuel cladding, which is unacceptable in terms of operational safety in a nuclear environment.

Advantageously, the zirconium alloy of the present invention which comprises 4 to 8% by weight of erbium has a set of properties which make it particularly well suited for use as a constituent material of a layer in a nuclear fuel cladding, since i) it is sufficiently laminable and ductile for parts with various forms to be shaped, ii) it has sufficient mechanical strength to support strains encountered within such a cladding since it shows, when it is a constituent of the intermediate layer of a nuclear fuel cladding, continuity of this mechanical strength with respect to the external and internal layers made of an industrially proven zirconium alloy, and iii) it is sufficiently rich in erbium to meet an overall poisoning requirement of up to 3% by weight of erbium in the overall cladding.

### 2—Manufacture by a Powder Metallurgy Process of a Tube and Cladding Having a Composite Structure According to the Present Invention

The powder metallurgy process according to the present present invention is particularly advantageous in certain applications (in particular when parts with a relatively complex geometry are desired) or when it is desired to reduce the amount of material involved and/or tooling pollution, for example during extrusion or rolling, as such a process does not require any shaping through material removal as is generally the case in a melting process.

Preferably, a component according to the present invention is a nuclear fuel cladding having a composite structure which comprises the following three successive layers:
an external layer consisting of metal or alloy;
an intermediate layer consisting of the zirconium alloy according to the present invention;
an internal layer consisting of metal or alloy.

Advantageously, because of this structure, the constituent metal or alloy of the external and/or internal layer may be different from the constituent metal or alloy of the intermediate layer, and may be optimized so as to have particular properties (in particular corrosion resistance, irradiation stability, mechanical toughness) and those properties which are required in the high burnup rate environment of a nuclear reactor, which is typically of the order of 100-120 GWd/tU (billion watt-days per ton of uranium). Thus, the above-mentioned corrosion problems of an erbium-containing zirconium alloy in an oxidizing medium are solved, in particular by a structure wherein the intermediate layer is protected from corrosion by the external layer and/or internal layer.

As a result, the zirconium alloy according to the present invention, which is a constituent of the intermediate layer, may be of the “low-alloyed” type, that is, may include little or no additives providing it with, for example, for example, corrosion resistance properties. Thus, preferably, the zirconium alloy of the present invention contains few additives, and comprises namely 0.005 to 1% by weight of additional elements.

As a consequence of this flexibility in the choice of the composition of the internal or external layer:
either the constituent metal or alloy of the external layer is the same as the constituent metal or alloy of the internal layer, such an alloy being preferably the M5® zirconium alloy (zirconium alloy with 1% by weight of zirconium), well known to one skilled in the art for having proven its properties of corrosion resistance (in particular through oxidation-hydride formation), irradiation stability (such as the lack of swelling/enlargement), and good mechanical toughness as a material in the nuclear fuel cladding);
or the constituent metal or alloy of the external layer is different from the constituent metal or alloy of the internal layer, wherein each composition of these layers may be optimized in order to obtain one or more specific properties. Therefore, advantageously, the external layer consists of the M5® alloy and the internal layer consists of a zirconium alloy capable of resisting internal stress corrosion.

Also, advantageously, whatever the internal or external layer composition selected, the constituent zirconium alloy of the intermediate layer further has a composition which is similar (or intermediate between the respective chemical compositions of the internal and external layers where the constituent alloys of these layers are different), except that it contains erbium, to the alloy of the external layer or internal layer, thus allowing, between these layers and allowing, between these layers and the intermediate layer, for a good metallurgical continuity ensuring optimal mechanical properties.

The manufacture by means of a powder metallurgy process of a three-layer nuclear fuel cladding according to the present invention is illustrated below, in addition to the manufacture of a two-layer cladding for comparison purposes.

Such a powder metallurgy process wherein a component is shaped by “pressing” offers a distinct advantage in the manufacture of a component having a more complex geometry than a plate, for example a tube.

Furthermore, this process makes it possible to mix together chemical constituents which are non-miscible and could not be mixed through more conventional processes such as arc-melting or consumable electrode melting. This is of particular interest, for example, in the manufacture of parts of the ceramics-metal or ceramics-alloy type.

Preferably, according to the present invention, the sintering step of the powder metallurgy process for the manufacture and, if required, shaping of the zirconium alloy is preceded by the following steps, performed in an inert atmosphere or vacuum:

a) filling a mold with a homogeneous powder comprising the zirconium, the erbium and the additional elements, followed, if required, by pre-compaction of the powder; and

b) cold-compacting the powder to obtain a molded compact blank; and

c) extracting the blank, followed, if required, by a machining step.

2.1—Manufacture by a Powder Metallurgy Process of the Cladding's Intermediate Layer According to the present Invention.

A layer of “Zr-D” zirconium alloy containing 4% or 5% by weight of erbium was obtained through powder metallurgy.

The erbium used was provided as oblong chippings with a striated and sheared surface having a small thickness and a maximum length of up to 600 μm.

As for the zirconium alloy, it consisted of a “Zr-D” zirconium alloy provided in the form of a powder produced by atomization and made of spherical particles (with an average diameter of approximately 100 μm) with a smooth surface. The oxygen content of this powder was approximately 1450 ppm by weight.

Before mixing it with the “Zr-D” zirconium alloy, erbium was crushed under an argon atmosphere in a planetary ball mill within a tungsten carbide jar for 15 minutes. Sieving was then performed to select diameters d<315 μm under an argon atmosphere inside a glove box.

The mixture of “Zr-D” zirconium alloy with 4 or 5% by weight of erbium was prepared inside a glove box. The total weight of the mixture was ˜1300 grams for the mixture comprising 4% by weight of erbium (used for making the internal layer of a two-layer nuclear fuel cladding) and 1400 grams for the second mixture comprising 5% by weight of erbium (used to make the intermediate layer of a three-layer nuclear fuel cladding).

The mixtures thus obtained of elementary powders of zirconium alloy and erbium were then cold-isostatically pressed (CIP) at 13,000 bars by means of an extrusion press. The compacts thus obtained were then machined in order to obtain a cylinder 47 mm in diameter and 85 mm in length which was clad within a titanium sheath under vacuum (while degassing through a seal weld), and was then subjected to a subjected to a solidification cycle through hot isostatic pressing (HIP) for 2 hours under an argon atmosphere at 1000° C. and 1500 bars.

The obtained cylinder was then machined (drilling and regrinding of the external diameter) into a hollow cylinder.

The dimensions of this cylinder were as follows, respectively:
intermediate layer of a three-layer cladding: external diameter of 41.5 mm and internal diameter of 33 mm;
intermediate layer of a two-layer cladding: external diameter of 46 mm and internal diameter of 37.5 mm.

2.2—Production of Nuclear Fuel Claddings Comprising an Intermediate Layer Manufactured According to a Powder Metallurgy Process.

In order to produce a three-layer and two-layer nuclear fuel cladding, a composite blank for extrusion was produced for each of these two claddings. It was composed of the following elements:
A “shell” into which the nuclear fuel cladding blank was inserted. It was made of an external cladding, an internal cladding and a plug, all three of which were made of a chromium-containing copper alloy to simultaneously ensure cohesion, thermal homogeneity and lubrication at the extrusion temperature.
For the internal ferrule (absent when a two-layer nuclear fuel cladding is manufactured) and the external ferrule, which will constitute the internal layer of the three-layer cladding and the external layer of the two- or three-layer claddings, an M5® zirconium alloy available from CEZUS in the form of an ingot 120 mm in diameter, was used. This ingot was was used. This ingot was shaped into a cylinder with a diameter of 73 mm by extrusion at 700° C. After machining, a ferrule in the form of a hollow cylindrical blank 170 mm in length, 66 mm in external diameter and 26 mm in internal diameter, was obtained.
For the internal layer (two-layer cladding) or the intermediate layer (three-layer cladding) of “Zr-D” erbium-containing zirconium alloy with 4% or 5% by weight of erbium, respectively, the hollow cylinders obtained according to the above example were used.

The dimensional characteristics were computed to obtain a nuclear fuel cladding blank having an external diameter of 18 mm and an internal diameter of 14 mm, after the coextrusion operation (these diameters correspond to a standard blank tube for use in the manufacture of nuclear fuel claddings of a PWR reactor).

The composite blank was coextruded over a mandrel at a temperature of 700° C. after pre-heating of the blank for 1 hour at this same temperature.

A container 73 mm in diameter, a steel die 19 mm in diameter, and a steel extrusion mandrel 13.5 mm in diameter were used. A high extrusion ratio was used (R=29), in order to obtain a very long tube (>3000 mm), 19 mm in external diameter and 13.8 mm in internal diameter.

The extruded tube thus obtained was then cut into three sections each approximately 1000 mm in unit length. Each section was then subjected to chemical etching in an acid bath (50% HNO₃) in order to remove the outer cladding and inner cladding made of copper.

After this operation, the three tubes obtained were ground, polished and turned. The dimensional specifications were, in particular, a constant thickness to within ±0.1 mm, a maximum eccentricity of 0.05 mm and an internal and external roughness of Ra<0.8 mm.

The final shaping consisted in performing five cold rolling passes using a non-specific guide rolling mill known as “HPTR” (to which a rolling process using a “pilger rolling mill” known to those skilled in the art may be substituted which is a priori more appropriate for the ultimate mechanical properties of the zirconium alloy of the present invention) to reduce the diameters and thickness of the tubes in order to achieve the dimensions of standard nuclear fuel claddings (external diameter=9.50 mm; internal diameter=8.35 mm; thickness=575 μm). A recristallization heat treatment (580° C. for 5 hours) under primary vacuum was carried out between each rolling pass to soften the material and thus restrict the risk of damage resulting from accumulated plastic deformation (strain hardening).

The final step in this manufacturing process consisted in performing a final heat treatment under vacuum (at 585° C. for 5 hours) on each tube.

At the end of the whole process, between 3 and 4 meters of the cladding prototype tube were obtained, distributed among three sections having a PWR geometry and a thickness of about 600 μm.

The external layer of M5® zirconium alloy (the two- or three-layer cladding) had a thickness of about 400 μm and provided most of the overall mechanical properties and external corrosion resistance under operating (and, as the case may be, accidental) conditions.

For the three-layer cladding, the intermediate layer (the “ZR-D” zirconium alloy comprising 5% by weight of erbium prepared by the powder metallurgy process) had a thickness of about 100 μm. As for the internal layer, it had a thickness of 100 μm and was made from the M5® zirconium alloy, knowing that another zirconium alloy may be appropriate, such as an alloy commonly used as the material for the internal layer of a BWR nuclear fuel cladding and specially optimized for internal stress corrosion resistance (if required, with the assistance of iodine), which phenomenon causes potential embrittlement and occurs during the pellet-nuclear fuel cladding interactions (PCI).

Thus the three-layer cladding according to the present invention is preferably such that:
the external layer has a thickness between 350 and 450 micrometers, preferably 400 micrometers;
the intermediate layer has a thickness between 50 and 150 micrometers, preferably 100 micrometers;
the internal layer has a thickness between 50 and 150 micrometers, preferably 100 micrometers.

These specific layer thicknesses advantageously lead to an external layer of substantial thickness with respect to the intermediate and internal layers (thus imparting to the nuclear fuel cladding optimal protection from the outside environment) while at the same time the thickness of the intermediate layer is such that the amount of erbium is sufficient to increase the burnup cycle length in a nuclear reactor. Thus, in practice, an intermediate layer having a thickness of 50 to 150 micrometers consisting of a zirconium alloy comprising approximately 12% by weight of erbium allows the overall poisoning of about 3% by weight of natural erbium to be met for the nuclear fuel cladding, which furthermore justifies the upper content limit of 3 to 12% (preferably 4 upper content limit of 3 to 12% (preferably 4 to 10%) by weight of erbium for the zirconium alloy of the present invention, in particular when the cladding is in the form of a tube.

To achieve an overall poisoning in the range between 0.8 and 3%, the three-layer fuel cladding wherein the intermediate layer consists of the zirconium alloy of the present invention comprising between 4 and 8% by weight of erbium, is preferably such that:
the external layer has a thickness between 150 and 450 micrometers, preferably 375 micrometers;
the intermediate layer has a thickness between 50 and 250 micrometers, preferably 100 micrometers;
the internal layer has a thickness between 50 and 150 micrometers, preferably 100 micrometers.

FIG. 4 illustrates the metallurgic structure obtained in the final product. It may be seen that there is an excellent metallurgic continuity between the three layers, which are labeled as follows in the figure: layer A (external layer of M5® zirconium alloy), layer B (intermediate layer of “Zr-D” zirconium alloy comprising 5% by weight of erbium), and layer C (internal layer of M5® zirconium alloy).

As a reference, control nuclear fuel claddings made of a single layer consisting of M5® alloy (without erbium) were manufactured according to the same process.

2.3—Mechanical Characteristics of Nuclear Fuel Claddings Comprising an Intermediate Layer Manufactured by a Powder Metallurgy Process

The usual mechanical characteristics obtained through internal pressure burst tests at 350° C. were measured on the PWR three-layer nuclear fuel cladding prototypes of the present invention, obtained according to the previous example.

For comparison purposes, these mechanical characteristics were also measured on control tubes (that is to say, single-layer claddings) consisting of erbium-free M5® zirconium alloy and on two-layer PWR nuclear fuel claddings obtained according to the previous example.

After hot and then cold shaping until the nuclear fuel cladding geometry of a PWR nuclear reactor was obtained, these nuclear fuel claddings and tubes manufactured according to the same manufacturing steps were all 1000 μm in length, 9.50 mm in external diameter, 8.35 mm in internal diameter and 575 μm in thickness.

Table 2 below shows the results of the mechanical tests performed. The abbreviations used have the same meaning as in Table 1. However, the mechanical characteristics shown in both tables may not be directly compared to each other, in particular due to the different geometries of the parts on which these mechanical tests were performed and the stress mode (internal pressure instead of tension).

It may be seen that the mechanical strengths of the various prototypes are comparable, some values however being slightly smaller for the two-layer prototype. However, a very small ductility may be observed for the two-layer prototype, whereas the three-layer prototype, although its total elongation at break is smaller than that of the control M5® zirconium alloy tube, has comparatively good ductility values in comparison with the reference, in particular with regard to the uniform elongation—this parameter being important and, in practice, relevant for the dimensioning of structures.

TABLE 2

| Tubular geometry - | Rp 0.2 | Rm | | |
|---|---|---|---|---|
| Total thickness ~575 μm | (Mpa) | (Mpa) | Ar (%) | At (%) |
| Control M5 ® without erbium - | 211 | 276 | 8.2 | 36.2 |
| sample #1 | | | | |
| Control M5 ® without erbium | 217 | 279 | 5.5 | 25.6 |
| sample #2 | | | | |
| 2-layer prototype (M5 ®/Zr-D, | 195 | 229 | 1.4 | 3.8 |
| erbium)- sample #1 | | | | |
| 2-layer prototype (M5 ®/Zr-D, | 219 | 241 | 1 | 3.9 |
| erbium)- sample #2 | | | | |
| 3-layer prototype (M5 ®/Zr-D, | 206 | 264 | 5 | 12.2 |
| erbium)- sample #1 | | | | |
| 3-layer prototype (M5 ®/Zr-D, | 198 | 261 | 6.3 | 12.2 |
| erbium)- sample #2 | | | | |

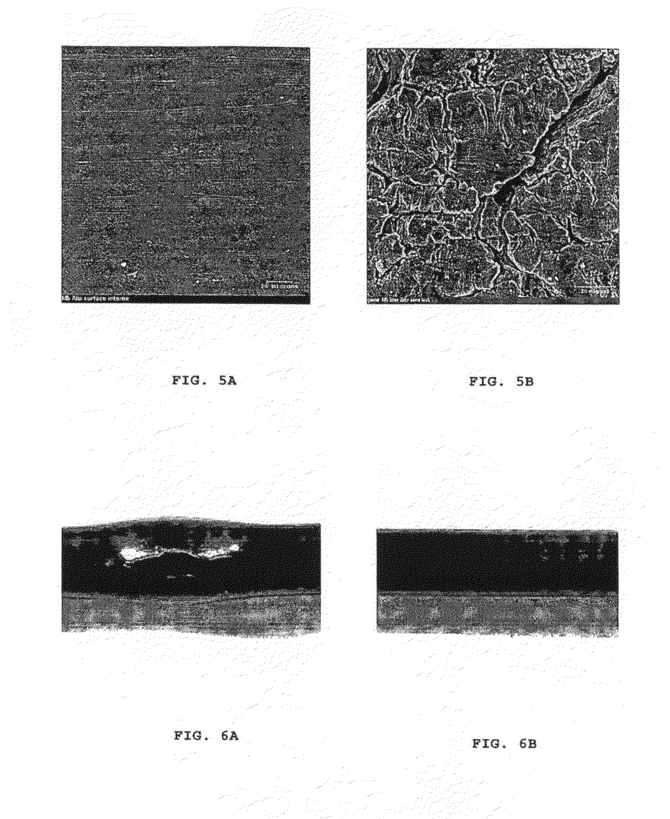

This mechanical behavior of a two-layer nuclear fuel cladding is illustrated in FIG. 5A (micrograph of the internal surface of a control single-layer nuclear fuel cladding consisting of erbium-free M5® zirconium alloy), which should be compared with FIG. 5B (micrograph of the internal surface of the two-layer cladding obtained according to the previous example, that is, comprising an external layer of M5® zirconium alloy and an internal layer of low-alloyed zirconium alloy (“Zr-D”) comprising 4% by weight of erbium).

As may be clearly seen, the internal surface condition of the erbium-containing cladding is substantially degraded.

This is caused, in particular, by the presence of oxide precipitates of varying coarseness generated within the internal layer by the powder metallurgy process, which would require some optimization—or advantageous replacement by replacement by the melting process described in the previous examples for plates—to restrict the growth of these oxides.

This presence of precipitates is found to be detrimental to the residual ductility of these claddings and may lead to substantial damage of the internal face of the two-layer cladding (crack initiation or even cracking), and also to the lack of significant ballooning followed by fracture during the above-mentioned burst tests.

This may be seen in FIGS. 6A and 6B, which illustrate the macroscopic aspect of the one- and two-layer nuclear fuel claddings whose internal surfaces are shown in FIGS. 5A and 5B, respectively. Although these claddings were manufactured using exactly the same manufacturing sequence, after the internal pressure burst tests at 350° C., the single-layer cladding of FIG. 6A alone has a normal break strength which is typical of an alloy free of oxide precipitates and therefore has a significant specific ductility (ballooning-induced fracture).

As for the three-layer nuclear fuel cladding, it does not have the same mechanical deficiencies, since the intermediate layer consisting of an erbium-containing zirconium alloy is protected by the external and internal layers of the nuclear fuel cladding. Therefore, this intermediate layer which alone comprises erbium cannot promote the formation of erbium oxide precipitates that show on the surface and are detrimental to the ductility of the cladding as a whole, as they create potential sites of early crack initiation, for example during the shaping (rolling) operations.

2.4—Properties with Respect to Hydride Formation in a Three-layer Nuclear Fuel Cladding.

Hydride formation is a phenomenon which occurs within within nuclear fuel claddings under normal operating conditions of a nuclear reactor or under accidental conditions.

It is caused by the following sequence of reactions (1) and (2): the zirconium contained in the nuclear fuel cladding is oxidized by pressurized water or water vapor according to the following reaction:

Zr+2H₂O->ZrO₂+2H₂, (1)

and the hydrogen thus released then diffuses throughout the zirconium alloys contained in the cladding (within the predominantly zirconium-alpha structure of these alloys) and may form a hydride with the not yet oxidized zirconium of the cladding, according to the following reaction:

Zr+xH->ZrHₓ. (2)

The subscript “x” indicates that hydrides of variable stoichiometry may form, where “x” may notably be equal to 2.

According to the overall hydrogen content and/or the temperature, all or part of the hydrogen will precipitate, the remainder being left in a solid solution (as interstitial matter into the zirconium-alpha crystal lattice).

For example, at 20° C., hydrogen almost entirely precipitates in the form of hydrides whereas the latter may entirely dissolve at higher temperatures (typically greater than 600° C.).

A shortcoming of solid solution hydrogen, especially in the form of a zirconium hydride precipitate, is that it reduces the ductility of zirconium alloys and therefore causes cladding embrittlement, in particular at low temperatures. This embrittlement is even more to be feared when the above-mentioned high burnup rates are desired because, at such rates, an increase in the oxidized zirconium proportion according to reaction (1) and therefore of the amount of hydrides formed according to reaction (2), is observed. In general, this then leads to corrosion of conventional industrial-grade alloys to unacceptable levels with regard to the cladding's safety and integrity criteria and poses problems with respect to post-service transportation and storage conditions.

To study the behavior of the zirconium alloy according to the present invention with respect to hydride formation, an experiment was carried out on the three-layer nuclear fuel cladding according to the present invention as obtained in the previous examples. The cladding's intermediate layer consists of a low-alloyed zirconium alloy (“Zr-D”) comprising, by weight, approximately 5% erbium.

The experiment involved forming hydrides in the three-layer nuclear fuel cladding as a whole by incorporating hydrogen into it through cathodic charging to an overall content of 400 to 450 ppm by weight, and then subjecting it to a 24-hr heat treatment at 430° C. in order to simulate high temperature dissolution and low temperature precipitation of hydrides under the normal operating conditions of a nuclear reactor and/or during post-service storage or transportation.

Cross-sections of the nuclear fuel cladding were taken and then subjected to a specific etching operation so as to reveal the zirconium hydride precipitates, and were thereafter inspected by optical micrography.

For comparison purposes, the same experiment was performed on a single-layer nuclear fuel cladding consisting of erbium-free M5® zirconium alloy and hydridized according to the same protocol (cathodic charging) until a comparable overall hydrogen content was achieved.

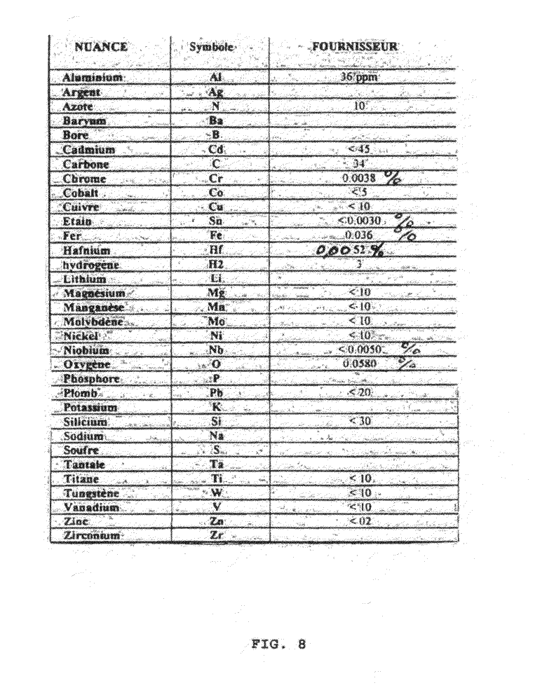

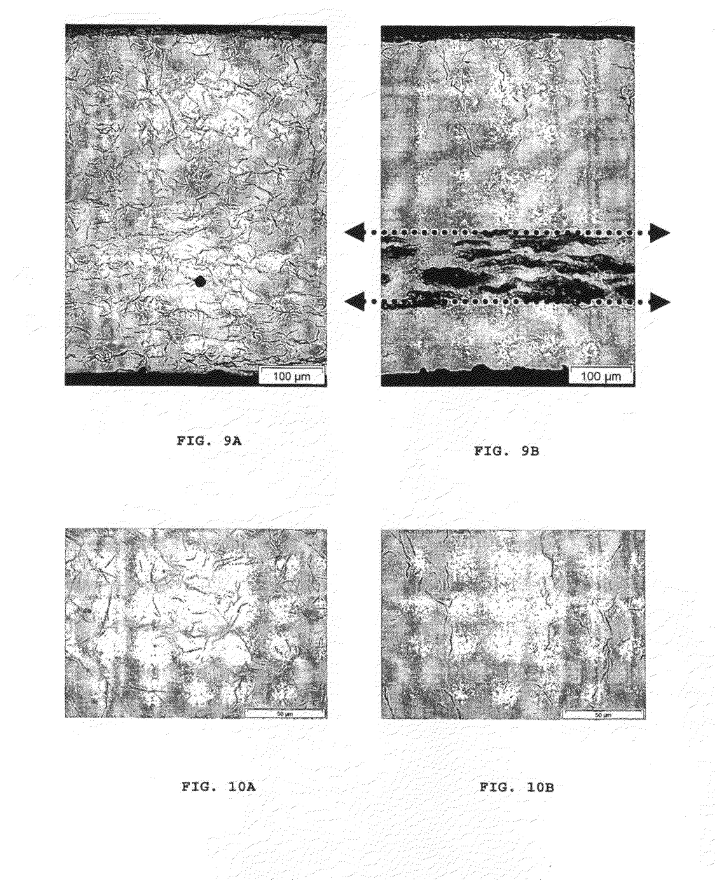

The optical micrographs obtained are shown in FIGS. 9A and 10A (single-layer cladding) and in FIGS. 9B and 10B (three-layer cladding). The zirconium hydride precipitates are seen to be in the form of more or less randomly oriented thin platelets of a dark grey color.

It may be clearly seen from these micrographs that, although the overall hydrogen content is the same, the amount of hydrogen in the form of zirconium hydride precipitates within the three-layer cladding is much smaller—or even nearly non-existent—in the external and internal layers of M5® alloy (which represent nearly 80% of the total thickness of the three-layer cladding) than in the single-layer cladding. The intermediate layer consisting of the erbium-containing zirconium alloy therefore behaves as if it “pumped” hydrogen, thus acting as a “sacrificial layer” within the three-layer nuclear fuel cladding.

In practice, such a behavior is highly advantageous since, for a given overall hydrogen content in the nuclear fuel cladding (that is, for a given burnup rate), the strong decrease (or even disappearance) of hydride precipitates in the external and internal layers of this three-layer cladding leads to a significant improvement in this cladding's residual ductility with respect to a single-layer cladding, and thus limits or even avoids any degradation in the cladding's structure and the possible problems of “local problems of “local over-concentration” of hydrides, combined with local exfoliation and/or cracking of the oxide.

The presence of the erbium-containing intermediate layer therefore leads to a significant benefit as regards the cladding's behavior (irradiated-oxidized-hydridized) both under nominal and accidental operating conditions of a nuclear reactor, and during post-service handling, transportation and storage operations.

Still more advantageously, the micrographs reveal a significant decrease in the amount of zirconium hydride precipitates even in the most remote areas of the intermediate layer, that is to say, areas which are closest to the external and internal surfaces of the three-layer nuclear fuel cladding. Therefore, the intermediate layer permits long-distance hydrogen “pumping”.

Yet, during the operation of a nuclear reactor, hydrides precipitate preferentially within the “coldest” area of the nuclear fuel cladding (namely that area which is most remote from the nuclear fuel) thus leading to a high concentration of such precipitates just below the oxide layer which normally forms at the surface of the cladding (this area usually being referred to as the “RIM of bulk hydrides”).

Therefore, this specific area is especially fragile because it may locally contain several thousand ppm by weight of hydrogen. Furthermore, because of the volume difference between the oxide and the zirconium alloy, this particular area (the alloy just below the oxide) is mainly subjected to tensile stress, and thus to possible damage, and crack initiation and propagation in this area.

When subjected to various types of stress, the three-layer nuclear fuel cladding according to the present invention therefore has a better mechanical behavior than a single-layer cladding, since the above-mentioned embrittled area is displaced towards the inner part of the cladding (not however to the point of reaching the internal surface of the cladding), thus delaying or even avoiding early initiation and propagation of a crack from the external surface of the cladding (more specifically, from the cladding's zirconium alloy-extern oxide interface), which could lead to the loss of the cladding's leak-tightness.

Similarly, during post-service storage and/or transportation, the residual power remaining in the fuel causes the nuclear fuel cladding to heat up to temperatures that may exceed 400° C. This results in total or partial dissolution of hydrides. On later cooling, hydrides may re-precipitate under stress (for example, under an internal pressure caused by the original pressurization gas and/or fission gases, or even by shocks or vibrations during transportation) and may therefore relocate in a manner which is detrimental (for example into the external layer of the cladding) to the residual ductility and/or toughness of the irradiated cladding. In the latter case, the presence of an intermediate layer that preferentially “pumps” hydrogen is here again very beneficial.

Finally, generally speaking, in the case of a hypothetical incidental or accidental scenario leading to a rise in temperature of the cladding to a level greater than its maximum operating temperature (approximately 360° C.), the preferential “pumping” of hydrogen by the intermediate “sacrificial” layer of a three-layer nuclear fuel cladding according to the present invention ensures high safety margins.

In order to obtain the above-mentioned hydrogen “pumping” effect, the zirconium alloy according to the present invention (which, if required, constitutes the intermediate layer of a three-layer nuclear fuel cladding according to the present invention) may contain:
in replacement of all or part of, or as a complement to erbium, at least one element selected from Dy, Gd, Sm, Eu;
as a complement only to erbium, at least one element selected from Ba, Ca, Ce, Ho, La, Li, Lu, Nd, Pr, Pu, Sc, Sr, Tb, Tm, Y, Yb; wherein such an element is capable of forming one or more hydrides which are more stable than zirconium hydrides, and which thus tend to replace zirconium hydrides.

### 3—Comparative Examples in Neutronics

According to the neutronic assessments performed by the inventors, the erbium content of the nuclear fuel cladding must preferably be between 0.8 and 3% by weight in order to reach a poisoning level which would be in accordance with the specifications of a burnable neutron poison used at a high burnup rate. To meet these specifications, one skilled in the art will be able to set the erbium content in the intermediate layer as a function of the latter's thickness in the nuclear fuel cladding.

The advantage, at the neutronic level, of the introduction of the zirconium alloy of the present invention into the nuclear fuel cladding is demonstrated in the following comparative examples which, by means of computational codes specifically developed by the inventors, simulate the change in negative reactivity (in pcm) as a function of the burnup rate expressed in MWd/t (million watt-days per ton) after various burnable neutron poisons have been introduced.

The following poisonings, computed so as to give the same initial efficiency, were thus performed:
a reference poisoning (1), as used industrially, given by 16 rods introduced into an assembly comprising, as the nuclear fuel, gadolinium-containing uranium oxide with 8% by weight of gadolinium;
poisoning (2) with 13.8% by weight of natural erbium introduced into the internal zirconium alloy layer of a two-layer nuclear fuel cladding, this internal layer representing a sixth of the nuclear fuel cladding's volume, corresponding to an overall cladding poisoning of ˜2.3% by weight;
poisoning (3) similar to poisoning (2), with the difference that the zirconium alloy comprises both natural erbium and its Er¹⁶⁷ isotope.

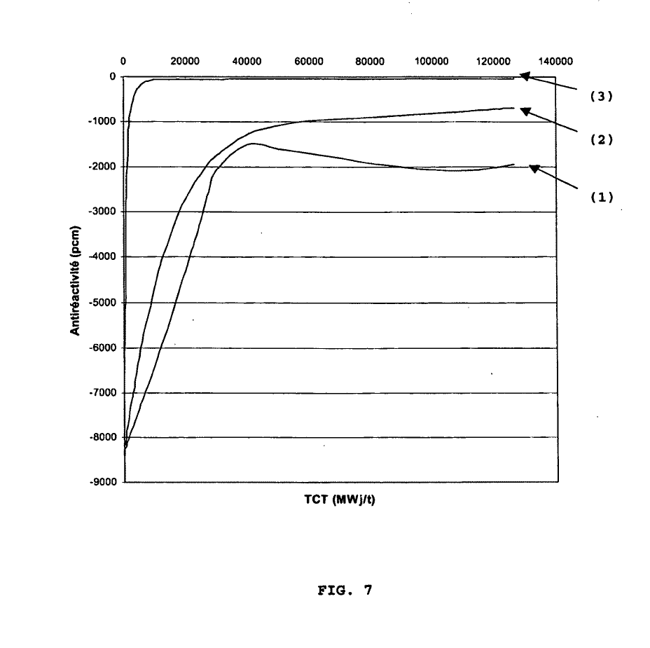

The results obtained are shown in FIG. 7. It may be seen that the wear kinetics of reference poisoning (1) are much too fast.

In contrast, the benefit of introducing erbium into the nuclear fuel claddings using poisoning (2) is demonstrated, and the residual penalty of erbium is even smaller than that of the reference poisoning (1).

Table 3 below shows the improvement in residual penalty as a function of the poisoning considered for the same initial efficiency.

TABLE 3

| | Improvement in residual |
|---|---|
| Studied case | penalty (%) |
| Reference poisoning (1) by | — |
| gadolinium rods | |
| Poisoning (2) by natural erbium in | −21% |
| the nuclear fuel claddings | |
| Poisoning (3) by ¹⁶⁷Er-enriched | −42% |
| erbium in the nuclear fuel claddings | |

As can be seen, the residual penalty may be further decreased by introducing erbium enriched with the absorbing ¹⁶⁷Er isotope into the nuclear fuel claddings and a slight increase in cycle length may thus be expected from this poisoning mode. A similar neutronic behavior may be expected for a three-layer nuclear fuel cladding according to the present invention.

Preferably, the zirconium alloy according to the present invention is therefore such that the erbium is selected from natural erbium, the ¹⁶⁷Er isotope and their mixtures.

Results similar to those presented in this example would be obtained with poisoning (2) in a three-layer nuclear fuel cladding.

### 4—Nuclear Reactor Core Computations

Core computations performed on the 100% UO₂ IN-OUT reference management mode for a PWR reactor also demonstrated the benefit of poisoning nuclear fuel claddings with erbium. With this management mode, the assemblies were enriched with ²³⁵U to 4.9% by weight. This is a quarter-core fuel management mode with an 18-month campaign length; the average burnup rate achieved is 60 GWd/t.

Two methods for poisoning 145 core assemblies were compared for this management mode: reference poisoning (1) using rods comprising gadolinium-containing uranium oxide as the fuel and poisoning (2) in which erbium is introduced into the nuclear fuel cladding (except that in this case, there is an overall poisoning of 1.3% by weight (instead of 2.3% by (instead of 2.3% by weight), so that the original erbium-related efficiency is the same as that obtained with gadolinium).

The results of this study are summarized in Table 4, which shows the values of the core reactivity coefficients at the beginning of the burnup cycle (or life) (no Xenon) and at the end of the burnup cycle.

They showed that with this management mode, it was possible to improve the power peaks within the core and, because of poisoning mode (2), to decrease the power ratio between the hottest rod in the core and the average rod (FAH) by about 3% with respect to the reference poisoning (1).

TABLE 4

| | Reference management | | Management poisoned by | |
|---|---|---|---|---|
| | poisoned by gadolinium | | natural erbium in the | |
| | rods (1) | | claddings (2) | |
| | Beginning | | Beginning | |
| | life | | life | |
| | No Xe | End of life | No Xe | End of life |
| Boron | −6.33 | −7.8 | −6.30 | −7.75 |
| efficiency | | | | |
| (pcm/ppm) | | | | |
| Doppler | −2.46 | −2.64 | −2.46 | −2.63 |
| coefficient | | | | |
| (pcm/° C.) | | | | |
| Moderator | −14.46 | −72.24 | −17.11 | −73.26 |
| temperature | | | | |
| coefficient | | | | |
| (pcm/° C.) | | | | |

Also, it appears that the moderator temperature coefficient was greater in absolute value when the management modes were controlled by poisoning (2) rather than by reference poisoning (1). A feature of erbium with respect to gadolinium is that it absorbs both in the thermal and the epithermal domains. Thus, in spite of an increase in moderator temperature, which leads to a decrease in water density and therefore to spectrum hardening, the absorption level of the erbium poisoning (2) is greater than that of the gadolinium reference poisoning (1), which, for its part, absorbs essentially in the thermal domain.

The use of erbium rather than gadolinium may therefore provide more flexibility by making it possible to introduce a greater boron concentration at the beginning of life if this proves necessary while meeting the negative moderator coefficient constraints. For example, the amount of erbium to be introduced into the nuclear fuel claddings can be slightly reduced by the addition of boron in order to preserve the original negative reactivity. It is also possible to take advantage of the possibility of increasing the original boron concentration in order to increase the original fuel enrichment and thus the burnup rate.

It was also possible through computations to find the optimal erbium content range needed to control the original over-reactivity of the fuel, in accordance with the management modes envisioned for future PWRs. The results are summarized in Table 5 below.

TABLE 5

| | 100% UO₂ Management | 100% UO₂ Management |
|---|---|---|
| | PWR Reference | Very high Burnup |
| | 4.9% ²³⁵U | 10% ²³⁵U |
| | Burnup = 60 GWd/t | Burnup = 126.4 GWd/t |
| | Quarter-core management | Eighth-core management |
| % by weight | ≈7.8% | ≈18.6% |
| of natural | | |
| erbium | | |

It is clear from the foregoing description that the zirconium alloy according to the present invention simultaneously has:
a ductility which makes it possible to manufacture and shape a structural component comprising this alloy,
a homogeneous microstructure (no segregation between zirconium and erbium),
a mechanical strength and toughness which guarantee good mechanical performance of the mechanical component, in particular at the operating temperatures of a nuclear reactor and/or under neutron irradiation,
a greater resistance to the potential embrittlement caused by in-service hydride formation and/or both under hypothetical accidental conditions and during post-service transportation and/or storage,
a sufficient amount of erbium as a burnable neutron poison so that this alloy may be incorporated into a component such as a nuclear fuel cladding, making it possible to achieve the desired poisoning when it is employed at high burnup rates (of up to 120 GWd/t), this being achieved being achieved without resorting to the use of erbium, which is mainly in the form of the ¹⁶⁷Er isotope.

### CITED REFERENCES

[1]—FR 2789404
[2]—U.S. Pat. No. 5,267,284
[3]—H. H. Klepfer, D. L. Douglass, J. S. Armijo, “Specific zirconium alloy design program”, First Quaterly Progress Report, (February-June 1962), GEAP-3979, US Atomic Energy Commission
[4]—U.S. Pat. No. 5,241,571
[5]—U.S. Pat. No. 5,267,290
[6]—U.S. Pat. No. 6,426,476
[7]—“Binary Alloy Phase diagrams”, 2nd Edition, Plus Updates, Copyright ASM International

1. A nuclear fuel cladding having a composite structure comprising the following three successive layers:
an external layer consisting of metal or alloy;
an intermediate layer;
an internal layer consisting of metal or alloy;
wherein said cladding is characterized in that the intermediate layer consists of a zirconium alloy comprising erbium as a burnable neutron poison, said zirconium alloy comprising, by weight:
from 4 to 8% natural erbium;
from 0.005 to 5% additional elements such as additives and/or manufacturing impurities;
and the remainder of zirconium.

2. The nuclear fuel cladding according to claim 1, characterized in that said constituent zirconium alloy of the intermediate layer comprises, by weight, from 5 to 7% erbium.

3. The nuclear fuel cladding according to claim 2, characterized in that said constituent zirconium alloy of the intermediate layer comprises, by weight, approximately 6% erbium.

4. The nuclear fuel cladding according to claim 1, characterized in that said zirconium alloy comprises, by weight, 0.005 to 1% of said additional elements.

5. The nuclear fuel cladding according to claim 1, characterized in that said additives comprise, by weight:
less than 3% niobium;
less than 2% tin;
less than 0.6% nickel;
less than 0.6% molybdenum;
less than 0.6% copper;
less than 0.6% iron;
less than 0.2% chromium;
less than 0.16% oxygen in a solid solution.

6. The nuclear fuel cladding according to claim 1, characterized in that said manufacturing impurities comprise, by weight:
less than 120 ppm silicon;
less than 100 ppm sulfur;
less than 20 ppm chlorine;
less than 10 ppm phosphorus;
less than 10 ppm boron;
less than 10 ppm calcium;
less than 50 ppm of each of the following elements: lithium, fluorine, heavy metals.

7. The nuclear fuel cladding according to claim 1, characterized in that said zirconium alloy further comprises ¹⁶⁷Er isotope in the form of a mixture with said natural erbium.

8. The nuclear fuel cladding according to claim 1, characterized in that erbium is distributed uniformly within the zirconium alloy and/or that there is no segregation of erbium in the form of erbium precipitates.

9. The nuclear fuel cladding according to claim 1, characterized in that all or part of the erbium is present in the zirconium alloy in the form of complex oxide precipitates which, by weight, contain mainly erbium.

10. The nuclear fuel cladding according to claim 9, characterized in that said precipitates have an average size of one micrometer or less.

11. The nuclear fuel cladding according to claim 10, characterized in that said precipitates have an average size of 500 nanometers or less.

12. The nuclear fuel cladding according to claim 11, characterized in that said precipitates have an average size lying in the range between 5 nanometers and 200 nanometers.

13. The nuclear fuel cladding according to claim 9, characterized in that said oxide precipitates are distributed uniformly within the zirconium alloy.

14. The nuclear fuel cladding according to claim 1, characterized in that the constituent metal or alloy of said external layer is different from the constituent metal or alloy of said internal layer.

15. The nuclear fuel cladding according to claim 14, characterized in that said external layer consists of M5 alloy and said internal layer consists of a zirconium alloy able to resist to internal stress corrosion.

16. The nuclear fuel cladding according to claim 1, characterized in that the constituent metal or alloy of said external layer is the same as the constituent metal or alloy of said internal layer.

17. The nuclear fuel cladding according to claim 1, further characterized in that the constituent zirconium alloy of said intermediate layer has a composition similar to that of the alloy of said external layer or said internal layer, except it comprises erbium.

18. The nuclear fuel cladding according to claim 1, characterized in that:
said external layer has a thickness between 350 and 450 micrometers;
said intermediate layer has a thickness between 50 and 150 micrometers;
said internal layer has a thickness between 50 and 150 micrometers.

19. A powder metallurgy process for the manufacture and, if required, the shaping of a nuclear fuel cladding according to claim 1, wherein said process comprises the sintering in an inert atmosphere or vacuum of said constituent zirconium alloy of said intermediate layer, followed, if required, by a machining step, wherein said alloy is in the form of a homogeneous powder.

20. The powder metallurgy process according to claim 19, characterized in that the following steps are performed in an inert atmosphere or vacuum prior to said sintering step:
a) filling a mold with a homogeneous powder comprising said zirconium, said erbium and said additional elements, followed, if required, by pre-compaction of said powder; and
b) cold-compacting said powder to obtain a molded compact blank; and
c) extracting said blank, followed, if required, by a machining step.

21. A melting process for the manufacture and, if required, the shaping of a nuclear fuel cladding according to claim 1, comprising the steps of:
melting and then solidifying a mixture of said zirconium, said erbium and said additional elements in a mold; and
if required, machining, such as milling and/or sandblasting.

22. The melting process according to claim 21, characterized in that said process further comprises one or more of the following steps:
remelting, followed by solidification, in a mold;
a heat treatment;
a hot and/or cold shaping step, for instance rolling;
machining, such as milling and/or sandblasting.

23. The melting process according to claim 22, characterized in that it comprises the following successive steps performed, if required, in an inert atmosphere or vacuum:
remelting, followed by solidification;
a first heat treatment;
machining;
a hot and/or cold shaping step;
machining;
a second heat treatment;
a final cold rolling;
a final heat treatment.

24. The melting process according to claim 23, characterized in that at least one of said heat treatments consists of heating at a temperature in the range between 600° C. and 1000° C.

25. The melting process according to claim 24, characterized in that at least one of said heat treatments consists of heating at a temperature of 800° C.

26. The melting process according to claim 24, characterized in that said heat treatment is the first heat treatment.
